(19) United States
(12) Patent Application Publication
(10) Pub. No.: US 2024/0342865 A1
(43) Pub. Date: Oct. 17, 2024

(54) Adjustable Clip

(71) Applicant: Marlan Goodwin, Upland, CA (US)

(72) Inventor: Marlan Goodwin, Upland, CA (US)

(21) Appl. No.: 18/605,834

(22) Filed: Mar. 15, 2024

Related U.S. Application Data
(60) Provisional application No. 63/452,442, filed on Mar. 16, 2023.

(51) Int. Cl. B25B 5/04; B25B 5/02

(52) U.S. Cl. CPC B25B 5/04; B25B 5/02

(57) ABSTRACT

This device is an adjustable clip to clamp materials together or onto other objects that are flat on at least two polar opposing faces. The device simply makes it possible to increase or decrease the distance between the open end of its' two opposing jaw structure components by using a connecting joint mechanism. This connecting joint mechanism located at the back end of each clamping jaw structure is able to be modified manually without the need of any tools. The object of the adjustable clip device is to provide the user with a range of selectable jaw positions in order to clamp, fasten or pinch varying thicknesses of materials. It is also an object of the adjustable clip to provide such versatile sizing options which are simple and convenient for the user to employ.

### CROSS REFERENCE TO RELATED APPLICATIONS

Provisional Patent Application #63/452,442

EFS ID 47690612

Filing Date Mar. 16, 2023

Confirmation No. 4729.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

This clamping device reduces the need for various sizes of clips. Most clips are made for specific applications and suffer from limitations that require multiple sizes of clips to be made in order to fit the wide variety of different items of varying thickness. Many other clips use spring loaded handles to create tension force. The Adjustable Clip uses a simple and less bulky design that does not need handles or springs to pinch the jaws closed or open. Additionally, the adjustable clip can adjust to fit onto a variety of objects that are different with respect to their thickness. The jaws of the adjustable clip manually adjust to multiple sizes in order to fit onto objects of varied thickness. This device relates to a clip that typically clamps, fastens or pinches various items. Oftentimes the existing clips are insufficient due to their lack of capacity to be modified for varying thicknesses of materials attempted to being clipped. Consequently, the materials being clipped require different size clips for varying thicknesses of materials being clipped. Therefore, it is essential that a clip that can be modified should be made. The product must be easily modified by the user and readily adjusted to the particular and varying conditions. Due to the high volume of circumstances which would require this device, the product also must be inexpensive. The adjustable clip readily adapts as needed. There are no adjustable clip devices known in prior art.

Many attempts have been made to create a device which clamps, fastens or adjoins to solve what has proven to be a longstanding problem such as the following prior art:

U.S. patent Ser. No. 10/527,200B2 to Andrew Leo Haynes, Christopher Charles Morrow, Michael John Sumner, Gabriel Ioan Giurgiu discloses an adjustable banded loop clip for securing a portion of a long thin item such as cable or pipe. The device is able to secure the gathered items at their length by enclosing the tail end of a loop into a sawtooth ratcheting mechanism.

US. Pat No. 921,887 to Olivia Hu, Ralph Sonderegger and Shaun Staley discuss a pinch clamp having a contiguous piece that locks into a pinched position at the front end of jaw. Additionally, this device locks the opposing jaw structure into a fixed position. In this design configuration, any gathered material would have to fit completely within the very limited space of the clip itself.

U.S. Pat. No. 5,329,672A to Froehlich and Froehlich discloses a paper clip that is formed from a single piece of spring-quality metal wire to have an elongated U-shaped inner loop nested within an elongated U-shaped outer loop. Each loop includes a free leg and a connector leg; the longitudinally-extending leg portions of the free leg and connector leg of each respective loop are of substantially the same length.

U.S. Pat. No. 3,913,586 to Baumgarten discloses an inexpensive, easily manufactured surgical hemostat comprising a pair of intersecting arms pivotally mounted on a common axis each arm having a plastic coating over its entire length, whereby the functional elements of the hemostat, i.e., the jaws, finger loops and latching means are formed from the plastic and the core provides the requisite strength and resiliency for the arms of the surgical hemostat.

U.S. Pat. No. 10,098,672 to Moskowitz Family discloses a Thoracic/lumbar and cervical spinous process staples which staple/fuse adjacent spinous processes are disclosed. Thoracic/lumbar transverse process staples which staple/fuse adjacent transverse processes are also disclosed. Each embodiment has upper and lower claws connected by a ratchet spring mechanism, along with a multiplicity of bone fastener prongs attached to the upper and lower claws.

### BRIEF SUMMARY OF THE INVENTION

Unlike conventional clips, the Adjustable Clip is constructed in a way that allows for the upper jaw (FIG. 1 part 1) and lower jaw (FIG. 1 part 2) to increase or decrease the distance between the opposing jaws opening. This adjustable clip can be used to clamp objects together or onto objects using an opposing grip created by the tension force from the jaws of the adjustable clip and the lower jaw ribs (FIG. 1 part 3). There are several embodiments for this concept. Our preferred embodiment (shown in FIGS. 1, 2 and 3) is to use a ratcheting saw tooth design to allow for the desired distance between the jaws. This preferred embodiment uses a male saw-toothed upper jaw (FIG. 1 part 4) and opposing female saw toothed lower jaw (FIG. 1 part 5) connection that can be joined in such a manner that it allows for the distance between the upper and lower jaws to be increased or decreased by simply pressing the male end more or less into the female connecting jaw. This embodiment also allows for the jaws to be separated, if needed, by simply sliding sideways the male end of the upper jaw out from the lower female jaw. In alternative embodiments, the Adjustable Clip could use many other methods to accomplish the same versatility and novelty such as pawl and ratchet mechanism combined with keyed pin hinge mechanism (FIGS. 4 thru 7) or compatible mating edges joint aka “puzzle joint” (FIGS. 8 thru 11) or a keyed pin saw tooth ratcheting mechanism (FIGS. 12 thru 14).

### BRIEF DESCRIPTION OF THE SEVERAL VIEWS OF THE DRAWING

The following drawings are to help illustrate the proposed invention but should not be limited to only what is shown. Rather, it is only the conceptual idea being shown in a variety of several possible embodiments.

FIG. 1 provides an angled perspective view displaying the chief components of this embodiment where the back end of the upper jaw (part 1) is in position where the male saw toothed end can be inserted into the female saw toothed back end of the lower jaw (part 2),

FIG. 2 again displays an angled perspective view where the male saw-toothed upper jaw has been partially inserted into the female saw toothed end of the lower jaw. The plurality of male saw teeth intermesh with the plurality of female saw teeth securing the positions until further pressed together.

FIG. 3 also provides an angled perspective view where the male back end of upper jaw is completely inserted into the back end of lower jaw's female saw teeth

### DETAILED DESCRIPTION OF THE INVENTION

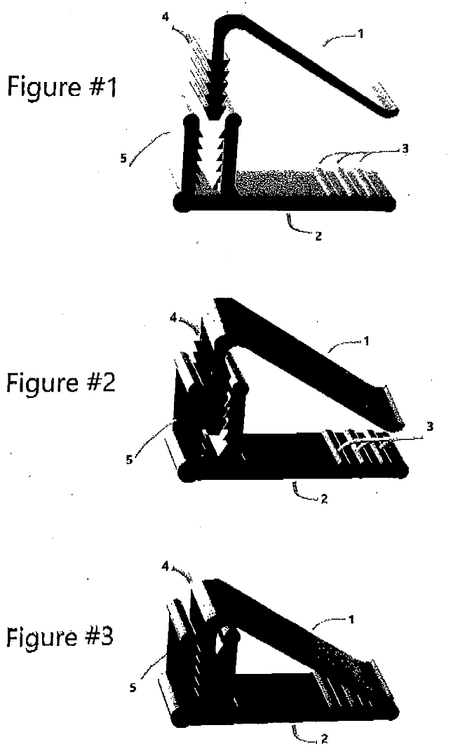

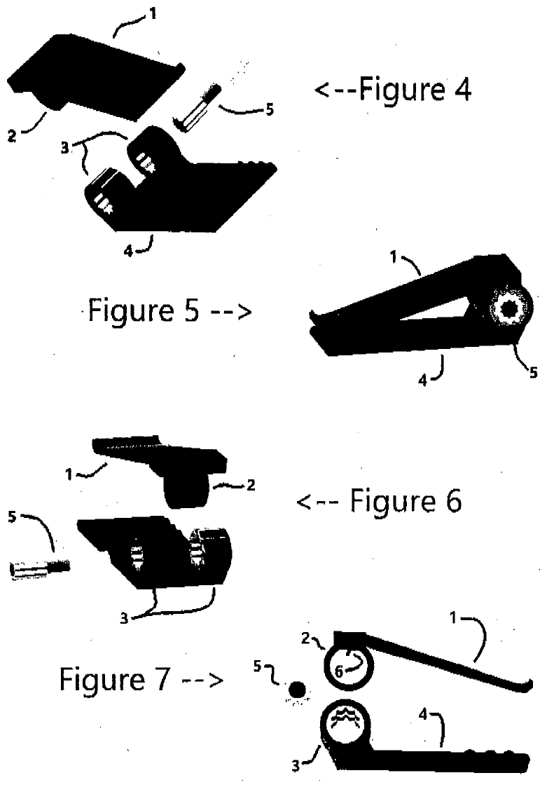

This invention will be made of a material that allows for flexion and contraction. The mechanism that accomplishes the goal of creating a varying degree of opposing jaw opening distance can be as illustrated in the drawings attached (FIGS. 1, 2 and 3) which use a male component (part 4) interposing itself into a female component with saw toothed elements (part 5) engaging each other while securing the upper (part 1) and lower jaw (part 2) as the ratcheting teeth intermesh with each other. If desired the two main parts, consisting of the upper jaw and lower jaw, can be separated by simply sliding the upper jaw sideways out from the lower jaw.

The drawings shown are to help illustrate the proposed invention but should not be limited to only what is shown. Rather, it is only the conceptual idea being shown in one of several possible embodiments.

FIG. 1 provides an angled perspective view displaying the chief components of this embodiment where the back end of the upper jaw (part 1) is in position whereby the male saw toothed end (part 4) can be inserted into the female saw toothed back end (part 5) of the lower jaw (part 2). Additionally, the ribbed protuberances (part 3) at distal end of lower jaw (part 2) can effectively increase the grip of this device.

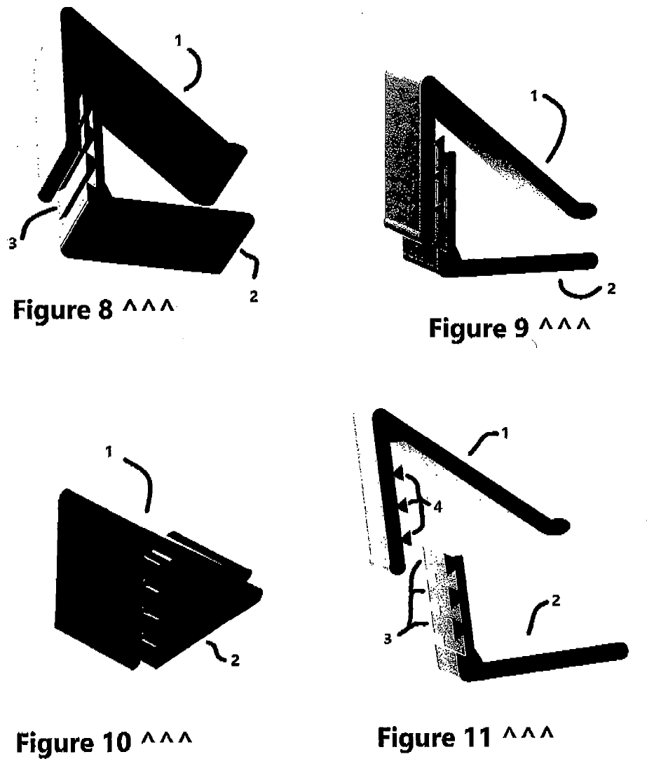

FIG. 2 again displays an angled perspective view where the male saw-toothed upper jaw (part 4) has been partially inserted into the female saw toothed end (part 5) of the lower jaw (part 2). The plurality of male saw teeth intermesh with the plurality of female saw teeth securing the positions until further pressed together.

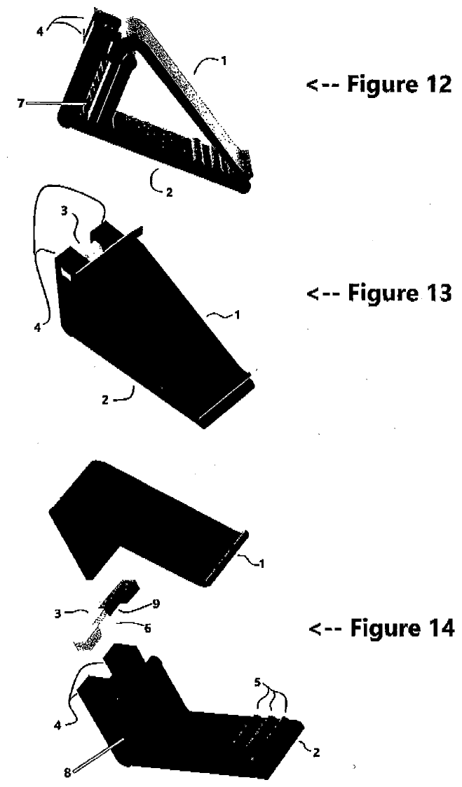

FIG. 3 also provides an angled perspective view where the male back end (part 4) of upper jaw (part 1) is completely inserted into the back end of lower jaw's female channel of saw teeth (part 5).

FIG. 4 illustrates an alternative embodiment which uses an upper jaw component (part 1) and lower jaw component (part 4) that are attached to each other using a barrel hinged joint (parts 2 & 3) that utilizes a unique splined pin (part 5) which allows for a full range of locking angles and if desired to easily release the locked position by sliding the splined hinge pin (part 5) through the barreled hinge knuckles (parts 2 & 3) which disengages the saw tooth ratcheting spline (part 5) from the pawl tooth (part 6 that is best seen in side view of FIG. 7), that is located within the centered barrel (part 2) of the upper jaw component (part 1).

FIG. 5 illustrates the same embodiment as FIG. 4 but in its' fully assembled and fully clamped position where the opening at the front of the upper jaw (part 1) and the lower jaw (part 4) has been closed completely.

FIG. 6 illustrates the same embodiment as FIG. 4 but at an angled view from the back side allowing a better view of the barrel hinge components (parts 2 and 3) and splined hinge pin (part 5). FIG. 7 illustrates the same embodiment as FIG. 4 but is a side view allowing a better view of the pawl tooth (part 6).

FIG. 8 illustrates yet another alternative embodiment which uses interposing dovetailed slotted connections (parts 3 & 4) to provide multiple positions for the upper jaw (part 1) to connect to the lower jaw (part 2). Dependent upon which of the male (part 4) and female (part 3) dovetail positions are combined will determine the opening distance at the mouth of the jaw created when pairing the upper (part 1) and lower jaw (part 2) together. The dovetail slots can be substituted with any other interlocking male to female designed joints.

FIG. 9 illustrates the same embodiment as FIG. 8 but from a rear angled view showing (part 1) and (part 2) joined.

FIG. 10 illustrates the same embodiment as FIG. 8 but from a rear angled view where it is more visible to see the joining of (part 1) with (part 2) using the lowest female channel slot on (part 3) which brings the front ends of both the upper jaw (part 1) and lower jaw (part 2) closer together

FIG. 11 illustrates a clearer view of the male dove tail protuberances (part 4) and the female slots (part 3) at the back end of lower jaw (part 2).

FIG. 12 illustrates yet another alternative embodiment which uses an upper jaw (part 1) and lower jaw (part 2) to create a clip fastener. These parts show a concept for attaching the upper and lower jaws combining the ratcheting mechanism of a saw-toothed male (part 7) at the back of upper jaw (part 1) that slides into a female channel slot (part 8). As the male ratcheted saw tooth shapes (part 7) meet with the pawl tooth section of the slide pin (part 6), the pawl tooth allows each saw tooth to pass downward into the female slot (part 8) but not upward unless the user pushes the slide pin (part 3) further across (part 4) which moves the pawl tooth away from its' engagement position and where the section (part 9) of slide pin (part 3) next to the pawl tooth (part 6) which has no engagement with the male saw tooth component (part 7) of the upper jaw thereby liberating it from the female slot (part 8) so the upper jaw (part 1) can be drawn up out from it. Additionally, the ribbed protuberances (part 5) at distal end of lower jaw (part 2) can effectively increase the grip of this device.

FIG. 13 illustrates the same embodiment as FIG. 12 but from a top angle which allows for a better view of (part 3) partially inserted through the two channel slots (part 4).

FIG. 14 illustrates the same embodiment as FIG. 12 but from an exploded parts view displaying the 3 key components of this embodiment

In use, the gap between adjustable clip's jaws is either increased or reduced to a distance that will allow, items being clamped, sufficient tension in order to maintain their collectively gathered positions. The user of the device can easily change the gap between the jaws if needed or remove the adjustable clip entirely.

Having described the device in its preferred embodiment, it should be clear that modifications can be made without departing from the spirit of the device. It is not intended that the words used to describe the device nor the drawings illustrating the same be limiting on the device. It is intended that the device only be limited by the scope of the appended claims.

I claim:

1. The adjustable clip is a clamping fastener with two opposing jaws wherein the improvement comprises a unique interposing joint mechanism allowing for the distance between the open end of the jaws to be manually increased or decreased without the need for tools. This device is made for use on a variety of different clamping, fastening or gathering scenarios wherein the device for clamping is adjustable to provide sufficient tension force so that flat faced materials that are gathered will remain clamped tightly and in order. said adjustable clip comprising:
(a) two elongated legs each have an open end with an inward face and further wherein the grabber means a set of ridges extending substantially horizontally across each inward face at the open ends of the elongated legs and
(b) a unique connecting joint mechanism wherein the elongated legs are joined at back ends of the opposing jaw structure as best seen in FIGS. 1,5, 9 and 12 and
(c) further wherein at least one of the two elongated legs have a distal end with a grabber means for gripping the gathered material.

2. The adjustable clip of claim 1 wherein the opening distance, between the two elongated leg ends of the clip member, is adjustable using a ratcheting saw tooth mechanism (FIGS. 1 thru 7 and 12 thru 14).

3. The adjustable clip of claim 1 (FIGS. 4 thru 7 and 12 thru 14) wherein the pawl tooth engages a saw tooth mechanism allowing the locking advancement of each saw tooth but not allowing the movement to regress unless the unique pawl tooth pin is shifted perpendicular so that the pawl tooth is no longer engaged with any saw tooth.

4. The adjustable clip of claim 1 further wherein the back end of upper jaw has corresponding male protuberances and back end of lower jaw has compatible female slotted channels and are used to select from a plurality of positions which when mated together result in the increase or decrease of the gap between the open jaw ends of the device as best seen in (FIGS. 8 thru 11).

5. The adjustable clip of claim 1 can be modified with ease by using several methods that allow the back end of the opposing jaws to interlock in variable positions without any tools where each variable position affects the distance increasing or decreasing between the opposing jaws at the open end.
